(19) United States
(12) Patent Application Publication
(10) Pub. No.: US 2023/0112376 A1
(43) Pub. Date: Apr. 13, 2023

(54) AGRICULTURAL SYSTEMS AND METHODS

(71) Applicant: Precision Planting LLC, Tremont, IL (US)

(72) Inventors: Michael Strnad, Delavan, IL (US); Jason J. Stoller, Eureka, IL (US); Paul Wildermuth, Tremont, IL (US)

(21) Appl. No.: 17/907,042

(22) PCT Filed: Mar. 25, 2021
(86) PCT No.: PCT/IB2021/052480

§ 371 Date: Sep. 22, 2022

Related U.S. Application Data
(60) Provisional application No. 63/004,690, filed on Apr. 3, 2020.
(60) Provisional application No. 63/004,704, filed on Apr. 3, 2020.

(51) Int. Cl. A01M 7/00; G06V 20/10

(52) U.S. Cl. CPC A01M 7/0089; G06V 20/188; H04N 7/181

(57) ABSTRACT

An agricultural implement having a camera facing in a forward direction of travel on the agricultural implement. A mirror is disposed in a portion of a forward field of view of the camera such that the camera captures an image that includes a forward field of view and a rearward view.

### CROSS-REFERENCE TO RELATED APPLICATIONS

This application claims the benefit of U.S. Provisional Application Nos. 63/004,690, filed 3 Apr. 2020, and 63/004,704, filed 3 Apr. 2020, which are incorporated herein in their entirety by reference.

### BACKGROUND

While conventional sprayer systems include various sensors to notify an operator if the application rate or droplet size of any or all of the spray nozzles are not within specified parameters, a need remains for a relatively inexpensive, yet effective way for an operator to verify that each spray nozzle is operating properly and with the desired spray pattern and droplet size. Additionally, while pin-point spraying of individual weed areas within a field is known, a need remains for a relatively inexpensive, yet effective way to verify that the individual weed areas are being sprayed by the spray nozzles.

### BRIEF DESCRIPTION OF THE DRAWINGS

FIG. 1 is a plan view representation of an agricultural sprayer implement traversing a field and includes a schematic illustration of a monitor system and sprayer controller. A plurality of cameras are shown supported by the sprayer boom with representations of the forward field of view (FOV) of each of the cameras.

FIG. 2 is a more detailed schematic illustration of the embodiment of the monitor system shown in FIG. 1.

FIG. 3 illustrates an embodiment of a process for setting up a monitor system and storing and mapping operational data.

FIG. 4 is an enlarged view of a portion of the sprayer boom of FIG. 1 showing one camera's forward FOV.

FIG. 5A is a schematic representation of a side elevation view of the sprayer boom showing a representation of the camera's forward FOV and showing a mirror disposed within the camera's forward FOV to capture an area of the field below and rearward of the camera reflected by the mirror.

FIG. 5B is an enlarged view of the camera and mirror of FIG. 5A illustrating a representation of the incident rays and reflected rays and the angles of incidence and the angles of reflection of the reflected area captured by the camera below and rearward of the camera.

FIG. 6 is a perspective view of an embodiment of a camera enclosure that may be operably supported from the sprayer boom.

FIG. 7A is similar to the schematic representation of FIG. 5A showing the camera enclosure of FIG. 6 operably supported on the sprayer boom traveling in a forward direction of travel.

FIG. 7B is a representation of a split-screen display showing a reflected area or “look-back” view in lower portion of the split-screen display and showing a remainder of the camera's forward FOV in an upper portion of the split-screen display.

FIG. 8A is the same representation as in FIG. 7A after the sprayer has advanced forwardly in the field.

FIG. 8B is the same representation as in FIG. 8B, but with the sprayer in the forwardly advanced position of FIG. 8A.

### DESCRIPTION

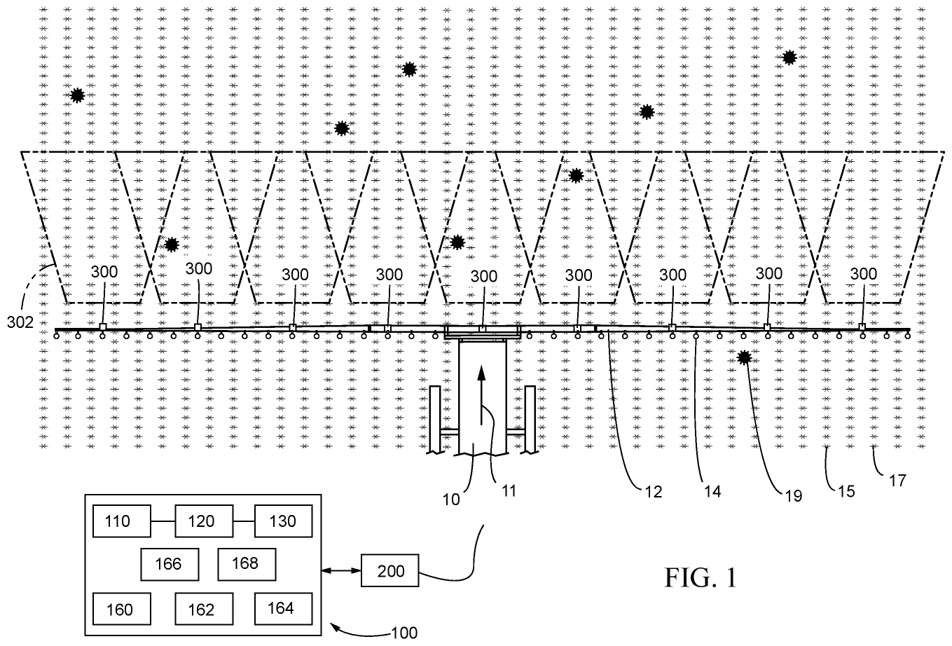

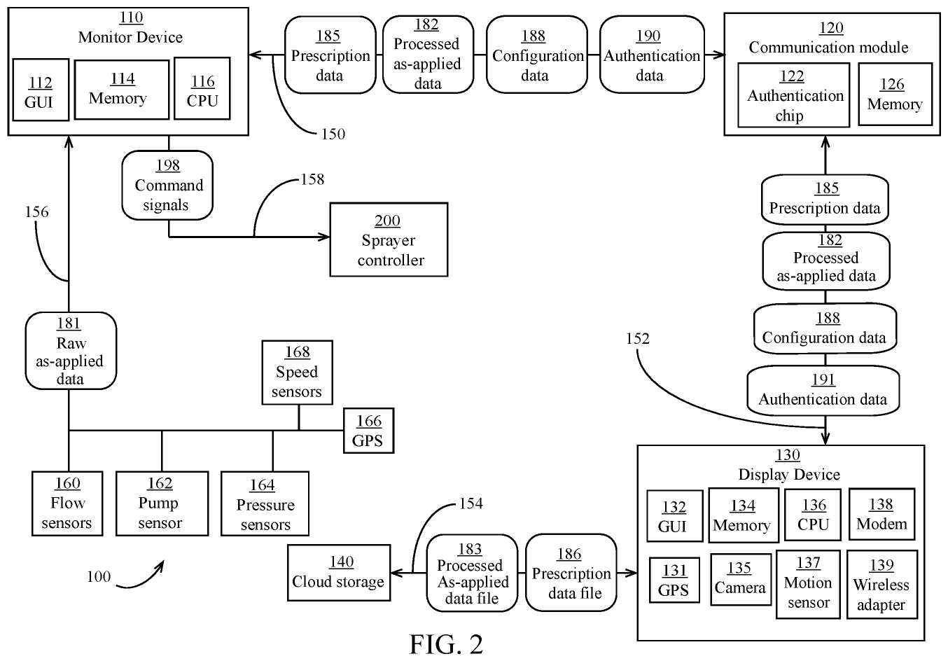

Referring now to the drawings, wherein like reference numerals designate identical or corresponding parts throughout the several views, FIG. 1 is a schematic plan view representation of an agricultural sprayer implement 10 traversing a field in a forward direction of travel 11. The agricultural sprayer 10 includes a spray boom 12 with spray nozzles 14 (FIG. 2) spaced along the width of the spray boom. For purposes of illustration only, and as a non-limiting example, the sprayer 10 is shown in FIG. 1 traversing a field planted with rows 15 of emerging or early stage row crops 17 and with the nozzles 14 shown spaced between the rows 15. FIG. 1 also shows weeds 19 growing in the field intended to be sprayed with herbicide as the spray boom 12 passes over the weeds 19 as will be discussed in more detail later.

The agricultural sprayer implement 10 may be a self-propelled sprayer carrying a supply of fluid product within one or more tanks (not shown) or the sprayer implement 10 may be a wheeled cart with one or more tanks drawn or pulled through the field by a tractor. In any of the foregoing sprayer implements, the spray boom 12 may be mounted on a forward end of the implement as shown in FIG. 1, or the spray boom 12 may be mounted at the rearward end of the implement (not shown).

As schematically illustrated in FIG. 1, the sprayer implement 10 includes a monitor system 100 which is in data communication with the sprayer controller 200. The sprayer controller 200 controls the operation of the sprayer implement 10. As is known in the art, the controller 200 communicates command signals for actuation or control over the sprayer implement's various controllable devices, including the actuators, nozzle actuators, valves and/or valve actuators, solenoids, pumps, meters, boom height controls, boom pitch controls, boom section controls, etc. The controller 200 may be coupled to various sensors such as pump sensors, flow rate sensors, pressure sensors, boom height or boom pitch sensors, which provide machine operating parameters for control over the respective components. The controller 200 may be coupled to environmental sensors that detect weather conditions, such as wind speed, wind direction, ambient temperature, barometric pressure, humidity, etc. The weather information may be used to control boom height, flow rate, and droplet size to minimize spray drift. Alternatively, or in addition, the environmental sensors may be omitted and weather information received by the controller 200 and/or from third party weather sources or from field stations located in proximity to the field being treated or the weather information may be communicated to the controller 200 via the monitor system 100.

The monitor system 100 is schematically illustrated in more detail in FIG. 2, and may include a monitor device 110, a communication module 120, and a display device 130. The monitor device 110 may include a graphical user interface (GUI) 112, memory 114, and a central processing unit (CPU) 116. The monitor device 110 is in electrical communication with the communication module 120 via a harness 150. The communication module 120 may include an authentication chip 122 and memory 126. The communication module 120 is in electrical communication with the display device 130 via a harness 152. The display device 130 may include a GUI 132, memory 134, a CPU 136 and a wireless Internet connection means 154 for connecting to a “cloud” based storage server 140. One such wireless Internet connection means 154 may comprise a cellular modem 138. Alternatively, the wireless Internet connection means 154 may comprise a wireless adapter 139 for establishing an Internet connection via a wireless router.

The display device 130 may be a consumer computing device or other multi-function computing device. The display device 130 may include general purpose software including an Internet browser. The display device 130 also may include a motion sensor 137, such as a gyroscope or accelerometer, and may use a signal generated by the motion sensor 137 to determine a desired modification of the GUI 132. The display device 130 may also include a digital camera 135 whereby pictures taken with the digital camera 135 may be associated with a global positioning system (GPS) position, stored in the memory 134 and transferred to the cloud storage server 140. The display device 130 may also include a GPS receiver 131.

### Monitor System Operation

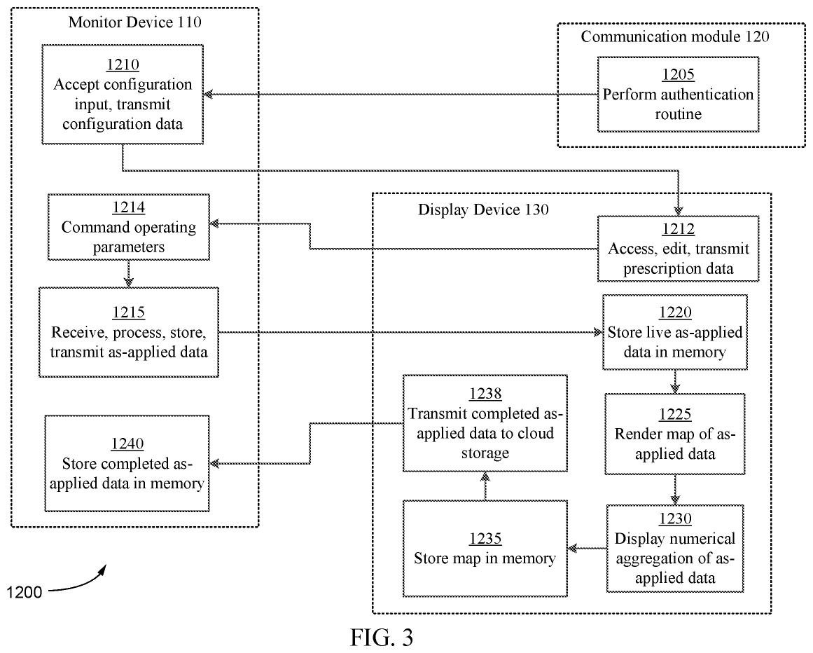

In operation, referring to FIG. 3, the monitor system 100 may carry out a process designated generally by reference numeral 1200. Referring to FIG. 3 in combination with FIG. 2, at step 1205, the communication module 120 performs an optional authentication routine in which the communication module 120 receives a first set of authentication data 190 from the monitor device 110 and the authentication chip 122 compares the authentication data 190 to a key, token or code stored in the memory 126 of the communication module 120 or which is transmitted from the display device 130. If the authentication data 190 is correct, the communication module 120 preferably transmits a second set of authentication data 191 to the display device 130 such that the display device 130 permits transfer of other data between the monitor device 110 and the display device 130 via the communication module 120 as indicated in FIG. 1.

At step 1210, the monitor device 110 accepts configuration input entered by the user via the GUI 112. In some embodiments, the GUI 112 may be omitted and configuration input may be entered by the user via the GUI 132 of the display device 130. The configuration input may comprise parameters preferably including dimensional offsets between the GPS receiver 166 and the spray nozzles 20 and the operating parameters of the sprayer 10 (e.g., nozzle type, nozzle spray pattern, orifice size, etc.). The monitor device 110 then transmits the resulting configuration data 188 to the display device 130 via the communication module 120 as indicated in FIG. 1.

At step 1212, the display device 130 may access prescription data files 186 from the cloud storage server 140. The prescription data files 186 may include a file (e.g., a shape file) containing geographic boundaries (e.g., a field boundary) and relating geographic locations (e.g., GPS coordinates) to operating parameters (e.g., product application rates). The display device 130 may allow the user to edit the prescription data file 186 using the GUI 132. The display device 130 may reconfigure the prescription data file 186 for use by the monitor device 110 and transmits resulting prescription data 185 to the monitor device 110 via the communication module 120.

At step 1214, as the sprayer implement 10 traverses the field, the monitor device 110 sends command signals 198 to the sprayer controller 200. These command signals 198 may include signals for controlling actuation of the pump, flow rate, line pressures, nozzle spray patterns, etc.

At step 1215, as the sprayer 10 traverses the field, the monitor device 110 records raw as-applied data 181 based on signals received from one or more of the various sensors on the sprayer implement 10 as discussed above (e.g., flow rate sensors, pressure sensors, pump sensors, speed sensors, etc.). The monitor device 110 also records GPS data signals from the GPS receiver. The monitor device 110 processes the raw as-applied data 181 to generate as-applied data of interest to the operator, such as application rates, droplet size, etc., associated with the GPS coordinates. The generated as-applied data is stored in memory 114. The monitor device 110 transmits the as-applied data 182 to the display device 130 via the communication module 120. The as-applied data 182 may be streaming, piecewise, or partial data.

At step 1220, the display device 130 receives and stores the as-applied data 182 in the memory 134. At step 1225, the display device 130 may render a map of the as-applied data 182 (e.g., a spray rate map or droplet size map) as described more fully elsewhere herein. An interface 90 allows the user to select which map is currently displayed on the screen of the display device 130. The map may include a set of application map images superimposed on an aerial image. At step 1230, the display device 130 displays a numerical aggregation of as-applied data (e.g., spray rate by nozzle over the last 5 seconds). At step 1235, the display device 130 preferably stores the location, size and other display characteristics of the application map images rendered at step 1225 in the memory 134. At step 1238, after completing spraying operations, the display device 130 may transmit the processed as-applied data file 183 to the cloud storage server 140. The processed as-applied data file 183 may be a complete file (e.g., a data file). At step 1240 the monitor device 110 may store completed as-applied data (e.g., in a data file) in the memory 114.

### Forward Field of View

Cameras 300 are spaced along the width of the spray boom 12. The cameras 300 may produce video images or still images. In the illustrated embodiment of FIG. 1, the spray boom 12 is shown as a 90 foot boom extending over crop rows 15 at 30 inch row spacings, such that there are a total of 9 cameras 300 spaced every four rows. It should be appreciated that more cameras at closer spacings or fewer cameras a greater spacings may be used. The forward field of view (FOV) 302 of each camera 300 is represented by the dashed trapezoidal lines in FIG. 1.

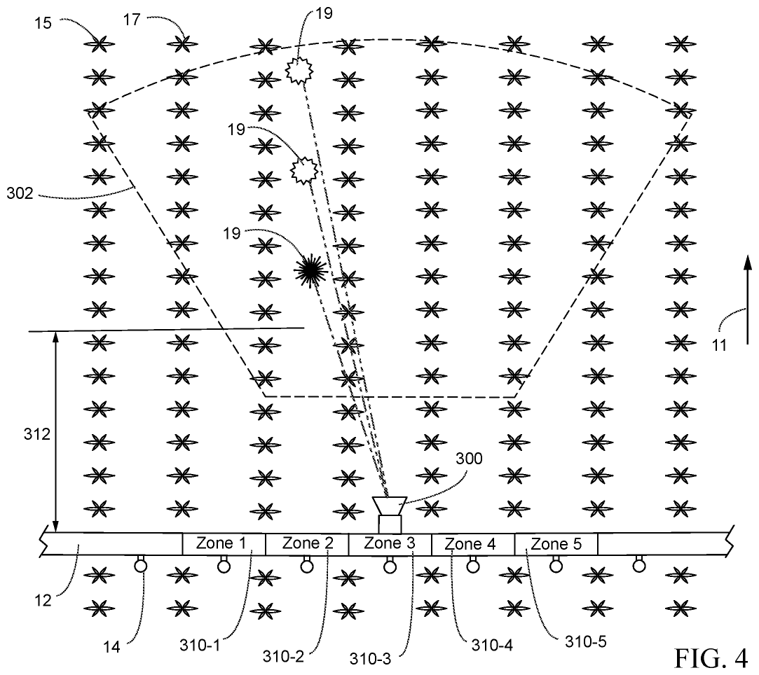

FIG. 4 is an enlarged view of a portion of the sprayer boom 12 and showing the forward FOV 302 of one of the cameras 300. By way of example, as shown in FIGS. 1 and 4, the forward FOV 302 of a camera 300 may extend 10 to 15 feet forward and may encompass a width of 12 to 18 feet at the forward end (or across 8 rows in the embodiment shown) and 5 to 7 feet at the narrow end (or across 4 rows in the embodiment shown). However, it should be appreciated that the dimensions of the area encompassed by the camera's forward FOV 302 will vary depending on the height of the camera above the soil surface and the angle of the camera with respect to horizontal.

In one embodiment as best viewed in FIG. 4, the forward FOV 302 of the camera 300 is divided into five zones (310-1 to 310-5). As the sprayer implement 10 advances through the field in the forward direction of travel 11, the presence of presumed weed areas 19 (along with the row crops 17, rocks, dirt clods, etc.) within each zone 310-1 to 110-5 will be captured in the camera's image frames. Each camera 300 is in data communication with the monitoring device 110 (see FIG. 2). The monitoring device 110 utilizes software to analyze the image frames of each zone 310-1 to 310-5 to differentiate between areas presumed to be weed areas 19 that are to be sprayed and other non-weed areas that need not be sprayed, such as crops 17, rocks, dirt clods, crop residue or debris. In addition, the software may be programmed to differentiate between different types of weeds based on leaf shape (e.g., broadleaf weeds vs. grass weeds vs. other). For small or emerging weeds, the type of weed may not be readily identifiable by the software, thus falling into the “other” category. The desirability of differentiating between types of weeds (e.g., broadleaf weeds vs. grass weeds) may be useful for applying different types of herbicides with different chemistries to better control the type of weed detected. Note, however, the particular software or algorithms utilized to differentiate between weeds 19 versus crops 17, rocks, dirt clods, crop residue, or debris or between different weed types is not part of the subject of the present disclosure.

Irrespective of the software or algorithms used to identify weed areas 19 versus non-weed areas, or between different weed types, the software compares each subsequent image frame to an immediately preceding image frame as the sprayer implement 10 advances through the field. If an area appearing on an image frame is presumed to be a weed area, a confidence value is associated with that weed area. It should be appreciated that if an area is flagged as a presumed weed area in an earlier image frame, that presumed weed area will also appear in subsequent image frames at different relative positions as the sprayer 10 advances through the field. By way of illustration, FIG. 4 shows the same weed area 19 detected in multiple image frames (e.g., at frame t, at frame t-1 and at frame t-2) as the sprayer implement 10 advances in the forward direction of travel 11. Each time the presumed weed area is captured in a subsequent image frame, the confidence value is increased. If the associated confidence value achieves a minimum defined confidence value, the nozzle 14 associated with the zone 310-1 to 310-5 in which the presumed weed area is located is actuated at the appropriate time (discussed below) to cause the presumed weed area to be sprayed. If the presumed weed area is not captured in a subsequent image frame, the associated confidence value is decreased. If the associated confidence value does not achieve the minimum defined confidence value, the nozzle 14 is not actuated to spray.

The software also determines the distance to each identified presumed weed area 19 within each zone 310-1 to 310-5 by taking into account various factors, including the speed and heading of the sprayer implement 10, the height of the camera 300 above the soil surface, and other latencies. FIG. 4 also identifies the minimum distance threshold 312 by which a presumed weed area 19 must be confirmed or identified as an area to be sprayed in order for there to be sufficient time to spray the presumed weed area 19 before it passes under the nozzle 14. The minimum distance threshold 312 may be calculated based on the following equation:

$$Minimum Distance Threshold ( ft ) = S \times \frac{5280}{3600} \times ( L 1 + L 2 + Ln )$$

Where: S=speed of the sprayer implement (mph)
   L1=detection latency and transmit latency (s)
   L2=control latency (s)
   Ln=other latency (s), if any

By way of example, if the speed of the implement sprayer 10 is 15 mph, the L1 is 200 ms, L2 is 50 ms and there is no other latency such that L3=0, the minimum distance threshold 312 would be 5.5 ft, i.e.:

$$Minimum Distance Threshold = 15 \times \frac{5280}{3600} \times ( 0.2 + 0.05 + 0 ) = 5.5 ft$$

### Look-Back View

In another embodiment, a mirror 400 is utilized to provide a “look-back” view to give the operator real-time, on-the-go confirmation as to whether the nozzles 14 are being actuated at the correct time to spray a previously identified weed as the nozzle passes over the weed and where the nozzle sprayed. The captured image frames of the look-back view can then be used to map where the nozzle sprayed within the field. This look-back view can also provide the operator with feedback regarding relative flow rates so the flow rates can be adjusted as needed.

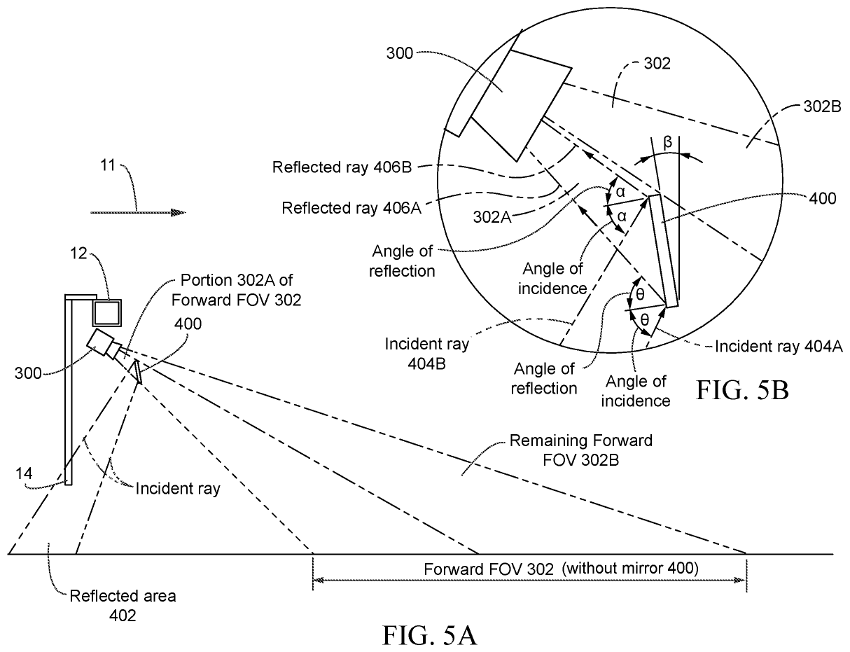

FIG. 5A is a schematic representation of a side elevation view of the sprayer boom 12 showing a representation of the forward FOV 302 of the camera 300. An enlarged view of the camera 300 and mirror 400 of FIG. 5A is illustrated in FIG. 5B. The mirror 400 is positioned within a portion 302A of the camera's forward FOV 302. The mirror 400 is oriented at an angle β with respect to vertical to produce a reflection of a desired area below and rearward of the camera 300 (the “reflected area” 402). The reflection of the reflected area 402 is captured by the portion 302A of the camera's forward FOV 302. The remaining portion of the forward FOV 302 (i.e., the forward FOV 302 that is not redirected by the mirror 400), is designated by reference number 302B and is discussed later.

In FIG. 5B, the reflected area 402 is represented by incident rays 404A, 404B and the corresponding reflected rays 406A, 406B defining the respective forward most and rearward most extremes of the reflected area 402. FIG. 5B shows the angle of incidence θ defined by the angle between the forward most incident ray 404A and the line perpendicular to the surface of the mirror 400 and the correspondingly equal angle of reflection θ defined by the angle between the reflected ray 406A and the line perpendicular to the surface of the mirror 400. Likewise, FIG. 5B shows the angle of incidence α defined by the angle between the rearward most incident ray 404B and the line perpendicular to the surface of the mirror and the correspondingly equal angle of reflection α defined by the reflected ray 406B and the line perpendicular to the surface of the mirror 400.

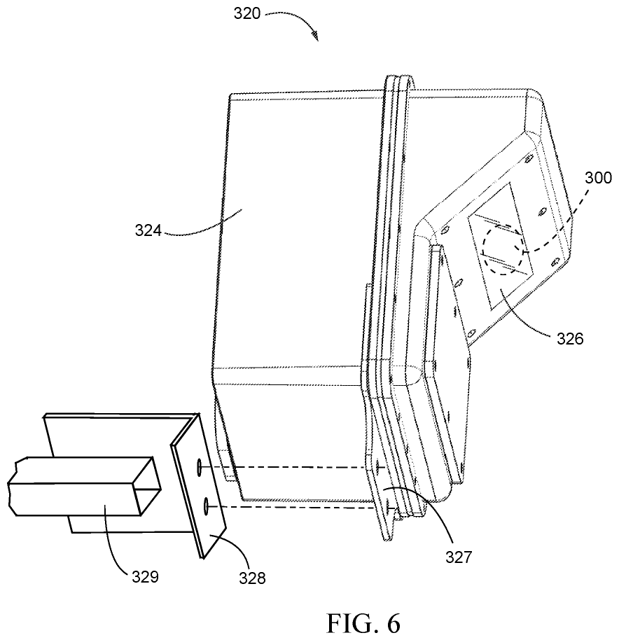

FIG. 6 is a perspective view of an embodiment of a camera enclosure 320 which protects the camera 300 from exposure to dust and moisture. The camera enclosure 320 includes a housing 324 with a window 326. The camera 300 is secured within the housing 324 behind the window 326, with the lens of the camera 300 looking outwardly through the window. The housing 324 may include a flange 327 adapted to secure to a mating plate 328 secured to a mounting bracket 329 operably supported from the sprayer boom 12.

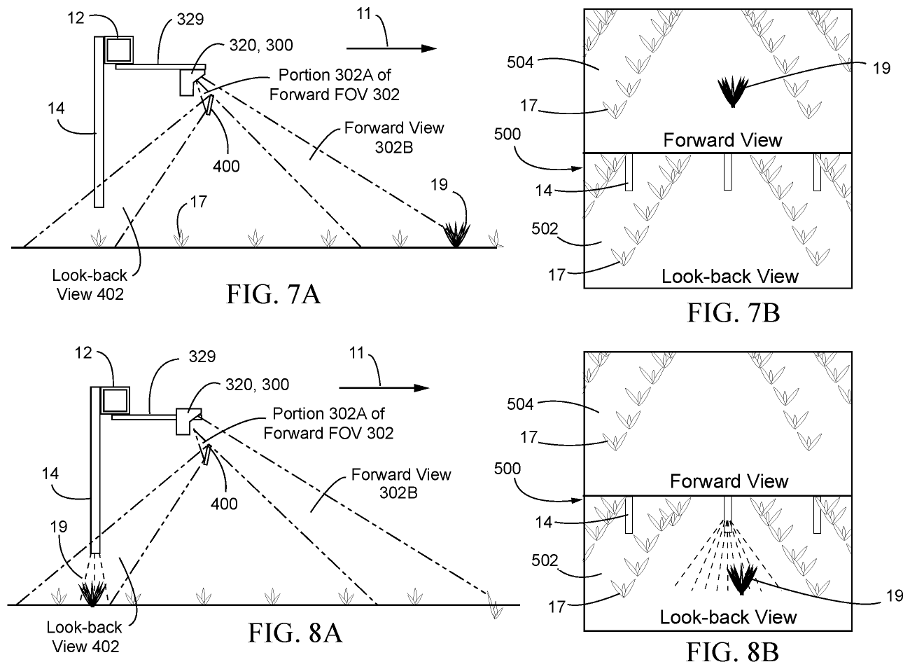

FIG. 7A is similar to the schematic representation of FIG. 5A showing the camera enclosure 320 of FIG. 6 operably supported on the sprayer boom 12 traveling in a forward direction of travel 11.

FIG. 7B is a representation of a split screen display 500 of the monitoring device 110 with the lower portion 502 of the split-screen 500 displaying the look-back view (i.e., the captured image frame of the reflected area 402 by the portion 302A of the camera's forward FOV 302). The upper portion 504 of the split-screen 500 displays the captured image frame of the remainder of the forward FOV 302B toward the direction of travel 11 and forward of the boom 12. FIG. 8A is the same representation as in FIG. 7A after the sprayer has advanced forwardly in the field. FIG. 8B is the same representation as in FIG. 7B but with the sprayer in the forwardly advanced position of FIG. 8A. As shown in FIG. 8B, it should be appreciated that the look-back view of the reflected area 402 provides the operator with real-time, on-the-go confirmation as to whether the nozzles 14 are being actuated at the correct time to spray a presumed weed area as the nozzle 14 passes over the presumed weed area 19. The look-back view also shows the operator where the nozzle 14 actually sprayed.

As with the forward FOV image frames, the look-back image frames may also be analyzed and compared with subsequent image frames. By knowing the percentage of split of the image captured by the camera 300 between the forward view and the look back view, the image frames can be separately processed. The percentage of split between the forward view and the look-back view may also be varied. It should be appreciated that the use of a mirror 400 associated with each forward facing camera 300 provides the operator with both a forward view of the field and a look-back view of the nozzles at substantially less cost than if both forward facing cameras and rearward facing cameras were used to provide the same forward view and look-back view.

With the comparison of the image frames of the look-back view (to establish when the nozzles were actuated or not actuated) combined with the GPS information as explained above, a more precise field map may be generated showing which areas of the field were sprayed. The sprayed areas of the field map may also be associated with flow rate information which may be color coded to represent different flow rates over different areas of the field. Such information may not be as readily discernable or as accurate if relying solely on signals generated by flow rate sensors.

Alternatively, in embodiments where the sprayer implement is used to spray an entire field, as opposed to pin-point spraying of individual weed areas as described above, the look-back view can also be used to confirm if a nozzle is spraying or not spraying, or whether the flow rate of a particular nozzle is the same compared to the flow rates of other nozzles commanded to spray at the same flow rate based on a prescription map. While the look-back view is not able to measure the actual flow rate of a nozzle, the relative flow rates can be determined by comparing video frames across the nozzles commanded to spray at the same flow rate. By determining a relative percentage of flow compared to other nozzles at the same flow rate, an actual flow rate can be calculated from the commanded rate and the percentage of flow. If the flow rate is lower than expected, the nozzle can be adjusted until the expected flow rate is achieved.

The foregoing description and drawings are intended to be illustrative and not restrictive. Various modifications to the embodiments and to the general principles and features of the system and methods described herein will be apparent to those of skill in the art. Thus, the disclosure should be accorded the widest scope consistent with the appended claims and the full scope of the equivalents to which such claims are entitled.

1. An agricultural system, comprising:
a camera operably supported by a boom of an agricultural implement, the boom extending transverse to a forward direction of travel of the agricultural implement, the camera oriented in a forward direction of travel of the agricultural implement such that the camera's forward field of view (FOV) is toward the forward direction of travel and forward of the boom, the camera configured to capture an image frame within the camera's forward FOV; and
a mirror positioned within a portion of the camera's forward FOV, the mirror oriented at an angle with respect to vertical so that the captured image includes a reflected area, the reflected area being below and rearward of the camera.

2. The agricultural system of claim 1 further comprising:
a monitor system including a display device visible to an operator of the agricultural implement, the monitor system having a split-screen, wherein a first screen of the split-screen displays a first portion of the captured image frame having the camera's forward FOV toward the direction of travel and forward of the boom and a second screen of the split-screen displays a second portion of the captured image frame having the reflected area.

3. The agricultural system of claim 1, wherein the agricultural implement is an agricultural sprayer.

4. The agricultural system of claim 3,
wherein the boom supports a plurality of spray nozzles spaced along the boom, each of the plurality of spray nozzles in fluid communication with a supply of fluid product via fluid supply lines;
further comprising a sprayer controller configured to control spraying of the fluid product from each of the plurality of spray nozzles; and
wherein the monitor system is in signal communication with the sprayer controller, the monitor system configured to send command signals to the sprayer controller to cause each of the plurality of spray nozzles to spray the fluid product on command as the agricultural implement travels through a field in the forward direction of travel.

5. The agricultural system of claim 4, further comprising a Global Positioning System (GPS) receiver in signal communication with the monitor system, the monitor system receiving GPS data from the GPS receiver, whereby as the agricultural implement traverses the field, the monitor system associates a respective location within the field of each of the plurality of spray nozzles based on the received GPS data.

6. The agricultural system of claim 5, further comprising flow rate sensors associated with each of the plurality of spray nozzles.

7. The agricultural system of claim 6, wherein the monitor system is configured to generate as-applied data based on output signals of the flow rate sensors and the respective location of each of the plurality of spray nozzles based on the received GPS data while the agricultural implement traverses the field.

8. The agricultural system of claim 7, wherein the display device is adapted to rendering an as-applied spray rate map based on the generated as-applied data.

9. The agricultural system of claim 7, wherein the display device is adapted to rendering an as-applied droplet size map based on the generated as applied data.

10. The agricultural system of claim 1, wherein the monitor system is configured to identify areas of the captured image frames as presumed weed areas to be sprayed, and wherein the monitor system assigns each presumed weed area a confidence value.

11. The agricultural system of claim 10, wherein as the agricultural implement advances in the forward direction of travel, the monitor system is configured to compare the captured image frame of the camera's then current forward FOV to the captured image frame of the camera's immediately preceding forward FOV, whereby if the presumed weed area in the captured image frame in the then current forward FOV corresponds to a previously identified presumed weed area in the captured image frame of the immediately preceding forward FOV, the confidence value is increased.

12. The agricultural system of claim 11, wherein as the agricultural implement advances in the forward direction of travel, the monitor system is configured to compare the captured image frame of the camera's then current forward FOV to the captured image frame of the camera's immediately preceding forward FOV, whereby if the presumed weed area in the captured image frame in the then current forward FOV does not correspond to any previously identified presumed weed area in the captured image frame of the immediately preceding forward FOV, the confidence value is decreased.

13. The agricultural system of claim 10, wherein the camera is one of a plurality of cameras, each of the plurality of cameras having its own forward FOV, and the forward FOV of each of the plurality of cameras is divided into distinct zones.

14. The agricultural system of claim 13, wherein the monitor system is configured to analyze the image frames of each of the distinct zones to identify presumed weed areas to be sprayed.

15. The agricultural system of claim 14, wherein as the agricultural implement advances in the forward direction of travel, the monitor system is configured to compare the captured image frame of each of the distinct zones of each camera's then current forward FOV to the captured image frame of each of the distinct zones of each camera's immediately preceding forward FOV, whereby if the presumed weed area in one of the distinct zones in the captured image frame in the then current forward FOV corresponds to a previously identified presumed weed area in that same one of the distinct zones in the captured image frame of the immediately preceding forward FOV, the confidence value is increased.

16. The agricultural system of claim 15, wherein as the agricultural implement advances in the forward direction of travel, the monitor system is configured to compare the captured image frame of each of the distinct zones of each camera's then current forward FOV to the captured image frame of each of the distinct zones of each camera's immediately preceding forward FOV, whereby if the presumed weed area in one of the distinct zones in the captured image frame in the then current forward FOV does not correspond to any previously identified presumed weed area in that same one of the distinct zones in the captured image frame of the immediately preceding forward FOV, the confidence value is decreased.

17. The agricultural system of claim 12, wherein, if the confidence value assigned to the presumed weed area is greater than a minimum confidence value, and a minimum distance threshold is met, the monitor system generates a command signal to cause the sprayer controller to actuate one of the plurality of spray nozzles that is laterally nearest to the presumed weed area to spray the fluid product onto the presumed weed area as the agricultural implement passes over the presumed weed area as the agricultural implement advances through the field in the forward direction of travel.

18. The agricultural system of claim 17, wherein the monitor system is configured to distinguish between certain weed types, and wherein the monitor system is configured to cause the sprayer controller to spray a different fluid product depending on which weed type is determined to be within the presumed weed area.

19. The agricultural system of claim 1, wherein each of the plurality of cameras is disposed within a camera enclosure supported from the boom.

20. The agricultural system of claim 19, wherein a lens of each of the cameras is disposed behind a window of the camera enclosure.

21. The agricultural system of claim 1, wherein the agricultural implement is self-propelled.

22. The agricultural system of claim 1, wherein the agricultural implement is a wheeled cart drawn by a tractor.
